(19) United States
(12) Patent Application Publication
(10) Pub. No.: US 2007/0191586 A1
(43) Pub. Date: Aug. 16, 2007

(54) Method for producing highly branched polyamides

(75) Inventors: Jean-Francois Stumbe, Strasbourg (FR); Bernd Bruchmann, Freinsheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/659,510

(22) PCT Filed: Aug. 2, 2005
(86) PCT No.: PCT/EP05/08337

§ 371 Date: Feb. 6, 2007

(30) Foreign Application Priority Data
Aug. 11, 2004 (DE) 10 2004 039 101.7

(51) Int. Cl. C08G 69/26; C08G 69/46

(52) U.S. Cl. 528/350; 528/332

(57) ABSTRACT

Process for preparation of highly branched or hyperbranched polyamides, which comprises reacting a first monomer A₂ having at least two functional groups A with a second monomer B₃ having at least three functional groups B, where 1) the functional groups A and B react with one another, and 2) one of the monomers A and B is an amine and the other of the monomers A and B is a carboxylic acid, and
3) the molar ratio A₂:B₃ is from 1.1:1 to 20:1.

The invention relates to a process for preparation of highly branched or hyperbranched polyamides, which comprises reacting a first monomer A₂ having at least two functional groups A with a second monomer B₃ having at least three functional groups B, where
1) the functional groups A and B react with one another, and
2) one of the monomers A and B is an amine and the other of the monomers A and B is a carboxylic acid, and
3) the molar ratio A₂:B₃ is from 1.1:1 to 20:1.

The invention further relates to the polyamides obtainable by the process, to their use for production of moldings, foils, fibers, or foams, and also to the moldings, foils, fibers, or foams composed of the polyamides.

Dendrimers can be prepared starting from one central molecule via controlled stepwise linkage of, in each case, two or more di- or polyfunctional monomers to each previously bonded monomer. Each linkage step here exponentially increases the number of monomer end groups, and this gives polymers with spherical dendritic structures, the branches of which comprise exactly the same number of monomer units. This “perfect” structure provides advantageous polymer properties, and by way of example surprisingly low viscosity is found, as is high reactivity, due to the large number of functional groups on the surface of the sphere. However, the preparation process is complicated by the fact that protective groups have to be introduced and in turn removed again during each linkage step, and cleaning operations are required, the result being that it is usual for dendritic polymers to be prepared only on a laboratory scale.

However, highly branched or hyperbranched polymers can be prepared using industrial processes. They also have linear polymer chains and uneven polymer branches alongside perfect dendritic structures, but this does not substantially impair the properties of the polymer when comparison is made with the perfect dendrimers. Hyperbranched polymers can be prepared via two synthetic routes known as the AB₂ and A₂+B₃ strategies. A and B here represent functional groups in a molecule. In the AB₂ route, a trifunctional monomer having one functionality A and two functional groups B is reacted to give a hyperbranched polymer. In the A₂+B₃ synthesis, a monomer having two functional groups A is first reacted with a monomer having three functional groups B. The product in the ideal case is a 1:1 adduct having only one remaining functional group A and two functional groups B, known as a “pseudo-AB₂ molecule, which then reacts further to give a hyperbranched polymer.

The present invention relates to the A₂B₃ synthesis, in which an at least difunctional monomer A₂ is reacted with an at least trifunctional monomer B₃.

EP-A 802 215 describes the preparation of polyamidoamines from end-group-capped linear prepolymers, reacting a dicarboxylic acid with a polyamine to give a prepolymer. Its chain ends are then reacted with the capping agent to give a polymer which has no amine end groups or carboxy end groups. Finally, these polymer chains are reacted with epichlorohydrin or with another “intralinker” to give the final product.

U.S. Pat. No. 6,541,600 B1 describes the preparation of water-soluble highly branched polyamides, inter alia from amines R(NH₂)ₓ and carboxylic acids R(COOH)_{y}, where each of x and y is at least 2 and x and y are not simultaneously 2. Some of the monomer units comprise an amine group, phosphine group, arsenine group, or sulfide group, and the polyamide therefore comprises N, P, As or S atoms, forming onium ions. The molar ratio of the functional groups is stated very broadly, NH₂:COOH or COOH:NH₂ being from 2:1 to 100:1.

EP-A 1 295 919 mentions the preparation of, inter alia, polyamides from monomer pairs Aₛ and Bₜ, where s≧2 and t≧3, for example from tris(2-ethylamino)triamine and succinic acid or 1,4-cyclohexanedicarboxylic acid in a molar triamine:dicarboxylic acid ratio of 2:1, i.e. using an excess of the trifunctional monomer.

US 2003/0069370 A1 and US 2002/0161113 A1 disclose the preparation of, inter alia, hyperbranched polyamides from carboxylic acids and amines, or of polyamidoamines from acrylates and amines, where the amine is at least difunctional and the carboxylic acid or the acrylate is at least trifunctional, or vice versa. The molar ratios of difunctional to trifunctional monomer may be smaller than or greater than one; no further details are given. Example 9 prepares a polyamidoamine by Michael addition from N(C₂H₄NH₂)₃ and N(CH₂CH₂N(CH₂CH₂COOCH₃)₂)₃.

The processes of the prior art are either inconvenient because they require two or more reaction steps, or use “exotic” and therefore expensive monomers. Furthermore, the resultant branched polymers have a structure with insufficient branching and therefore have unsatisfactory properties.

An object was to eliminate the disadvantages described. In particular, the intention was to provide a process which can prepare hyperbranched polyamides in a simple manner, if possible in a one-pot reaction.

The process should start from commercially available, low-cost monomers.

Furthermore, the resultant polyamides should feature an improved structure, in particular via a more ideal branching system.

The process defined at the outset has accordingly been found, as have the polymers obtainable thereby. Furthermore, the use mentioned has been found, as have the moldings, foils, fibers, and foams mentioned. Preferred embodiments of the invention are found in the subclaims.

Among the highly branched and hyperbranched polyamides for the purposes of the invention are highly branched and hyperbranched “polyamidoamines” (see the specifications mentioned: EP-A 802 215, US 2003/0069370 A1, and US 2002/0161113 A1).

Although the first monomer A₂ can also have more than two functional groups A, it is here termed A₂ for simplicity, and although the second monomer B₃ can also have more than three functional groups B it is here termed B₃ for simplicity. The important factor is simply that the functionalities of A₂ and B₃ are different.

According to condition 1) of the main claim, the functional groups A and B react with one another. The selection of the functional groups A and B is therefore such that A does not react with A (or reacts only to an insubstantial extent) and B does not react with B (or reacts only to an insubstantial extent), but A reacts with B.

According to condition 2) of the main claim, one of the monomers A and B is an amine and the other of the monomers A and B is a carboxylic acid.

Preferably, and according to condition 2a) of claim 2, the monomer A₂ is a carboxylic acid having at least two carboxy groups, and the monomer B₃ is an amine having at least three amino groups. As an alternative, and according to condition 2b) of claim 2, the monomer A₂ is an amine having at least two amino groups, and the monomer B₃ is a carboxylic acid having at least three carboxy groups.

Suitable carboxylic acids usually have from 2 to 4, in particular 2 or 3, carboxy groups, and have an alkyl, aryl, or arylalkyl radical having from 1 to 30 carbon atoms.

Examples of dicarboxylic acids which may be used are: oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and also cis- and trans-cyclopentane-1,3-dicarboxylic acid, and the dicarboxylic acids here may have substitution by one or more radicals selected from:

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, or n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl,

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl and 2-naphthyl, particularly preferably phenyl.

Examples which may be mentioned of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, and 3,3-dimethylglutaric acid.

Other suitable compounds are ethylenically unsaturated dicarboxylic acids, such as maleic acid and fumaric acid, and also aromatic dicarboxylic acids, such as phthalic acid, isophthalic acid, or terephthalic acid.

Examples of suitable tricarboxylic acids or tetracarboxylic acids are trimesic acid, trimellitic acid, pyromellitic acid, butanetricarboxylic acid, naphthalenetricarboxylic acid, and cyclohexane-1,3,5-tricarboxylic acid.

It is also possible to use mixtures of two or more of the abovementioned carboxylic acids. The carboxylic acids may either be used as they stand or in the form of derivatives. These derivatives are in particular
the anhydrides of the carboxylic acids mentioned, and specifically in monomeric or else polymeric form;
the esters of the carboxylic acids mentioned, e.g.
   mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
   mono- and divinyl esters, and also
   mixed esters, preferably methyl ethyl esters.

It is also possible to use a mixture composed of a carboxylic acid and of one or more of its derivatives, or a mixture of two or more different derivatives of one or more dicarboxylic acids.

The carboxylic acid used particularly preferably comprises succinic acid, glutaric acid, adipic acid, phthalic acid, isophthalic acid, terephthalic acid, or mono- or dimethyl esters thereof. Adipic acid is very particularly preferred.

Suitable amines usually have from 2 to 6, in particular from 2 to 4, amino groups, and an alkyl, aryl, or arylalkyl radical having from 1 to 30 carbon atoms.

Examples of diamines which may be used are those of the formula R¹—NH—R²—NH—R³, where R¹, R², and R³, independently of one another, are hydrogen or an alkyl, aryl, or arylalkyl radical having from 1 to 20 carbon atoms. The alkyl radical may be linear or in particular for R² may also be cyclic.

Examples of suitable diamines are ethylenediamine, the propylenediamines (1,2-diaminopropane and 1,3-diaminopropane), N-methylethylenediamine, piperazine, tetramethylenediamine (1,4-diaminobutane), N,N′-dimethylethylenediamine, N-ethylethylenediamine, 1,5-diaminopentane, 1,3-diamino-2,2-diethylpropane, 1,3-bis(methylamino)propane, hexamethylenediamine (1,6-diaminohexane), 1,5-diamino-2-methylpentane, 3-(propylamino)propylamine, N,N′-bis(3-aminopropyl)piperazine, N,N′-bis(3-aminopropyl)piperazine, and isophoronediamine (IPDA).

Examples of suitable triamines, tetramines, or higher-functionality amines are tris(2-aminoethyl)amine, tris(2-aminopropyl)amine, diethylenetriamine (DETA), triethylenetetramine (TETA), tetraethylenepentamine (TEPA), isopropylenetriamine, dipropylenetriamine, and N,N′-bis(3-aminopropylethylenediamine).

Aminobenzylamines and aminohydrazides having 2 or more amino groups are likewise suitable.

The amines used particularly preferably comprise DETA or tris(2-aminoethyl)amine or a mixture of these.

It is also possible to use a mixture of two or more carboxylic acids or carboxylic acid derivatives, or a mixture of two or more amines. The functionality of the various carboxylic acids or amines here may be identical or different.

In particular if the monomer A₂ is a diamine, the monomer B₃ used may comprise a mixture of dicarboxylic acids and tricarboxylic acids (or higher-functionality carboxylic acids), the average functionality of the mixture B₃ being at least 2.1. By way of example, a mixture composed of 50 mol % of dicarboxylic acid and 50 mol % of tricarboxylic acid has an average functionality of 2.5.

Similarly, if the monomer A₂ is a dicarboxylic acid, the monomer B₃ used may comprise a mixture of diamines and triamines (or higher-functionality amines), the average functionality of the mixture B₃ being at least 2.1. This variant is particularly preferred. By way of example, a mixture composed of 50 mol % of diamine and 50 mol % of triamine has an average functionality of 2.5.

The reactivity of the functional groups A of the monomer A₂ may be identical or different. Equally, the reactivity of the functional groups B of the monomer B₃ may be identical or different. In particular, the reactivity of the two amino groups of the monomer A₂ or of the three amino groups of the monomer B₃ may be identical or different.

In one preferred embodiment, the carboxylic acid is the difunctional monomer A₂ and the amine is the trifunctional monomer B₃, and this means that it is preferable to use dicarboxylic acids and triamines or higher-functionality amines.

The monomer A₂ used particularly preferably comprises a dicarboxylic acid, and the monomer B₃ used particularly preferably comprises a triamine. The monomer A₂ used very particularly preferably comprises adipic acid and the monomer B₃ used very particularly preferably comprises diethylenetriamine or tris(2-aminoethyl)amine.

According to condition 3) of the main claim, the molar ratio A₂:B₃ is from 1.1:1 to 20:1. According to the invention, therefore, a defined excess (not, for example, any desired excess) is used of the difunctional monomer A₂. The molar ratio A₂:B₃ is preferably from 1.1:1 to 10:1. In the case of two-stage or multistage reaction as described below, this molar ratio is the molar ratio over all of the stages.

The reaction of the monomers A₂ and B₃ may be carried out in one stage, by combining A₂ and B₃ in the appropriate molar ratio and reacting them immediately to give the final polyamide product. In this single-stage reaction, the reactivity of the functional groups B of the monomer B₃ is preferably identical. The molar ratio A₂:B₃ for the single-stage reaction is from 1.1:1 to 20:1, preferably from 1.1:1 to 10:1, and particularly preferably from 1.2:1 to 3:1.

The amino groups are particularly preferably identical, and the molar ratio A₂:B₃ is particularly preferably from 1.2:1 to 3:1.

In another, particularly preferred embodiment, the reaction of A₂ and B₃ is carried out in two or more stages, in particular two stages. This reaction in two or more stages is particularly preferred when the reactivity of the functional groups B of the monomer B₃ is different.

In the case of a two-stage reaction, the first stage reacts A₂ in a large molar excess over B₃; the molar ratio A₂:B₃ in this first stage is in particular from 2.5:1 to 20:1, preferably from 2.5:1 to 6:1. The large molar excess of A₂ produces a prepolymer having free (unreacted) end groups A. In many instances, a rapid rise in the viscosity of the reaction mixture is observed at the end of the first stage, and this can be utilized to discern the end of the reaction.

In the second stage, the resultant prepolymer is reacted with further monomer B₃ to give the final product, whereupon the end groups A of the prepolymer react with B₃. Instead of the monomer B₃, use may also be made of a monomer B₂ having two functional groups B (instead of three or more, as is the case with B₃).

Accordingly, in one preferred embodiment the amino groups are different, and the monomers A₂ and B₃ are reacted in a molar A₂:B₃ ratio of from 2.5:1 to 20:1, producing a prepolymer having the functional groups A as end groups, and this prepolymer is then reacted with further monomer B₃ or with a monomer B₂ having two functional groups B.

By way of example, the first stage may react a triamine B₃ with a large molar excess of dicarboxylic acid A₂ to give a prepolymer having carboxy end groups, and the second stage may react this prepolymer with further triamine B₃ or with a diamine B₂ to give the final product. The mixture mentioned, composed of diamine and triamine, with an average functionality of at least 2.1, is also suitable as triamine B₃.

Similarly—bus less preferably—the first stage may react a tricarboxylic acid B₃ with a large molar excess of diamine A₂, to give a prepolymer having amino end groups, and the second stage may react this prepolymer with further tricarboxylic acid B₃ or with a dicarboxylic acid B₂ to give the final product. The mixture mentioned, composed of dicarboxylic acid and tricarboxylic acid, with an average functionality of at least 2.1, is also suitable as tricarboxylic acid B₃.

The amount of the monomer B₃ or B₂ required in the second stage depends, inter alia, on the number of free end groups A in the prepolymer. An example of a method for determining this end group content of the prepolymer is titration to give the acid number to DIN 53402-2.

The amount usually used of the monomer B₃ or B₂ per mole of end groups A is from 0.25 to 2 mol, preferably from 0.5 to 1.5 mol. The amount preferably used of B₃ or B₂ per mole of end groups A is about 1 mol, for example 1 mol of triamine or diamine per mole of carboxy end groups. By way of example, the monomer B₃ or B₂, may be added all at once, batchwise in two or more portions, or continuously, e.g. in accordance with a linear, rising, falling, or step function.

The two stages can be carried out in a simple manner in the same reactor; there is no requirement for isolation of the prepolymer or for introduction and, in turn, removal of protective groups. It is also possible, of course, to use another reactor for the second stage.

If the reaction is carried out in more than two stages, either the first stage (preparation of the prepolymer) and/or the second stage (reaction with B₃ or B₂) may be executed in two or more substages.

The multistage reaction permits preparation of hyperbranched polyamides with relatively high molecular weights. Variation of the molar ratios here can give polymers which have defined terminal monomer units (end groups of the branches of the polymers). By way of example, polyamides having terminal amino groups may be prepared.

The two-stage reaction can moreover prepare polymers with a relatively high degree of branching (DB). The degree of branching is defined as

$$DB = \frac{T + Z}{T + Z + L}$$

where T is the number of terminal monomer units, Z is the number of branched monomer units, and L is the number of linear monomer units.

In the case of the polyamides obtained via single-stage reaction, the degree of branching DB is usually from 0.2 to 0.7, preferably from 0.3 to 0.6 and in particular from 0.35 to 0.55. In the case of the polyamides obtained via two-stage reaction, the degree of branching DB is usually from 0.3 to 0.8, preferably from 0.35 to 0.7 and in particular from 0.4 to 0.7.

During or after the polymerization of the monomers A₂ and B₃ to give the hyperbranched polyamide, concomitant use may be made of difunctional or higher-functionality monomers C acting as chain extenders. This can control the gel point of the polymer (juncture at which insoluble gel particles are formed via crosslinking reactions, see by way of example Flory, Principles of Polymer Chemistry, Cornell Univerity Press, 1953, pp. 387-398), and modify the architecture of the macromolecule, i.e. the linkage of the monomer branches.

Accordingly, one preferred embodiment of the process makes concomitant use, during or after the reaction of the monomers A₂ and B₃, of a monomer C acting as chain extender.

Examples of suitable chain-extending monomers C are the abovementioned diamines or higher-functionality amines, which react with the carboxy groups of different polymer branches and thus bond them. Particularly suitable compounds are ethylenediamine, the propylenediamines (1,2-diaminopropane and 1,3-diaminopropane), N-methylethylenediamine, piperazine, tetramethylenediamine (1,4-diaminobutane), N,N′-dimethylethylenediamine, N-ethylethylenediamine, 1,5-diaminopentane, 1,3-diamino-2,2-diethylpropane, 1,3-bis(methylamino)propane, hexamethylenediamine (1,6-diaminohexane), 1,5-diamino-2-methylpentane, 3-(propylamino)propylamine, N,N′-bis(3-aminopropyl)piperazine, N,N′-bis(3-aminopropyl)piperazine, and isophoronediamine (IPDA).

Amino acids of the general formula H₂N—R—COOH are also suitable as chain extenders C, R here being an organic radical.

The amount of the chain extenders C depends in the usual way on the desired gel point or the desired architecture of the macromolecule. The amount of the chain extender C is generally from 0.1 to 50% by weight, preferably from 0.5 to 40% by weight, and in particular from 1 to 30% by weight, based on the entirety of the monomers A₂ and B₃ used.

The inventive process can also prepare functionalized polyamides. For this, concomitant use is made of monofunctional comonomers D, which may be added prior to, during or after the reaction of the monomers A₂ and B₃. This method gives a polymer chemically modified by the comonomer units and their functional groups.

One preferred embodiment of the process therefore makes concomitant use, prior to, during, or after the reaction of the monomers A₂ and B₃, of a comonomer D having a functional group, giving a modified polyamide.

Examples of these comonomers D are saturated or unsaturated monocarboxylic acids, or else fatty acids, and their anhydrides or esters. Examples of suitable acids are acetic acid, propionic acid, butyric acid, valeric acid, isobutyric acid, trimethylacetic acid, caproic acid, caprylic acid, heptanoic acid, capric acid, pelargonic acid, lauric acid, myristic acid, palmitic acid, montanic acid, stearic acid, isostearic acid, nonanoic acid, 2-ethylhexanoic acid, benzoic acid, and unsaturated monocarboxylic acids, such as methacrylic acid, and also the anhydrides and esters, such as acrylic esters or methacrylic esters, of the monocarboxylic acids mentioned.

Examples of suitable unsaturated fatty acids D are oleic acid, ricinoleic acid, linoleic acid, linolenic acid, erucic acid, and fatty acids derived from soy, linseed, castor oil, and sunflower.

Particularly suitable carboxylic esters D are methyl methacrylate, hydroxyethyl methacrylate, and hydroxypropyl methacrylate.

Other comonomers D which may be used are alcohols, and also fatty alcohols, e.g. glycerol monolaurate, glycerol monostearate, ethylene glycol monomethyl ether, the polyethylene monomethyl ethers, benzyl alcohol, 1-dodecanol, 1-tetradecanol, 1-hexadecanol, and unsaturated fatty alcohols.

Other suitable comonomers D are acrylates, in particular alkyl acrylates, such as n-butyl acrylate, isobutyl acrylate, tert-butyl acrylate, lauryl acrylate, stearyl acrylate, or hydroxyalkyl acrylates, such as hydroxyethyl acrylate, hydroxypropyl acrylate, and the hydroxybutyl acrylates. The acrylates may be introduced in a particularly simple manner into the polymer via Michael addition at the amino groups of the hyperbranched polyamide.

The amount of the comonomers D depends in the usual way on the extent to which the polymer is to be modified. The amount of the comonomers D is generally from 0.5 to 40% by weight, preferably from 1 to 35% by weight, based on the entirety of the monomers A₂ and B₃ used.

Depending on the nature and amount of the monomers used, and on the reaction conditions, the hyperbranched polyamide may have terminal carboxy groups (—COOH) or terminal amino groups (—NH, —NH₂), or both. The selection of the comonomer D added for functionalization depends in the usual way on the nature and number of the terminal groups with which D reacts. If carboxy end groups are to be modified, it is preferable to use from 0.5 to 2.5, preferably from 0.6 to 2, and particularly preferably from 0.7 to 1.5, molar equivalents of an amine, e.g. of a mono- or diamine, and in particular of a triamine having primary or secondary amino groups, per mole of carboxy end groups.

If amino end groups are to be modified, it is preferable to use from 0.5 to 2.5, preferably from 0.6 to 2, and particularly preferably from 0.7 to 1.5, molar equivalents of a monocarboxylic acid per mole of amino end groups.

As mentioned, Michael addition may also be used to react amino end groups with the acrylates mentioned, the number of acrylate molar equivalents used for this purpose preferably being from 0.5 to 2.5, in particular from 0.6 to 2, and particularly preferably from 0.7 to 1.5, per mole of amino end groups.

The number of free COOH groups in (acid number of the final polyamide product is generally from 0 to 400, preferably from 0 to 200, mg KOH per gram of polymer and may be determined, for example, via titration to DIN 53240-2.

The following comments relate to the reaction conditions:

The monomers A₂ are generally reacted with the monomers B₃ at an elevated temperature, for example at from 80 to 180° C., in particular from 90 to 160° C. It is preferable to operate under an inert gas, e.g. nitrogen, or in vacuo, in the presence or absence of a solvent, such as water, 1,4-dioxane, dimethylformamide (DMF), or dimethylacetamide (DMAC). Examples of solvent mixtures with good suitability are those composed of water and 1,4-dioxane. However, there is no need to use a solvent; by way of example, the carboxylic acid may be used as initial charge and melted, and the amine may be added to the melt. The water of reaction formed during the course of the polymerization (polycondensation) is, by way of example, drawn off in vacuo or is removed via azeotropic distillation, using suitable solvents, such as toluene.

If the polymerization is undertaken in two stages, the end of the first stage (reaction of B₃ with a large excess of A₂) may, as mentioned, often be discerned via the sudden onset of a rapid rise in the viscosity of the reaction mixture. When the viscosity rise begins, the reaction may be terminated, for example via cooling. The number of end groups in the prepolymer may then be determined on a specimen of the mixture, for example via titration to DIN 53402-2 to give the acid value. In the second stage, the prepolymer is then reacted to give the final product by adding that amount of monomer B₃ or B₂ which is required by the number of end groups.

The pressure is generally non-critical, being from 1 mbar to 100 bar absolute, for example. If no solvent is used, the water of reaction can be removed in a simple manner by operating in vacuo, e.g. at from 1 to 500 mbar.

The reaction time is usually from 5 minutes to 48 hours, preferably from 30 min to 24 hours, and particularly preferably from 1 hour to 10 hours.

The reaction of carboxylic acid and amine may take place in the absence or presence of catalysts. Examples of suitable catalysts are the amidation catalysts mentioned at a later stage below.

If concomitant use is made of catalysts, their amount is usually from 1 to 5000 ppm by weight, preferably from 10 to 1000 ppm by weight, based on the entirety of the monomers A₂ and B₃.

During or after the polymerization process, the chain extenders C mentioned may be added, if desired. For chemical modification of the hyperbranched polyamide it is also possible to add the comonomers D mentioned, prior to, during, or after the polymerization process.

The reaction of the comonomers D may be catalyzed via conventional amidation catalysts, if required. Examples of these catalysts are ammonium phosphate, triphenyl phosphite, or dicyclohexylcarbodiimide. In particular when using heat-sensitive comonomers D, and when using methacrylates or fatty alcohols as comonomer D, the reaction may also be catalyzed via enzymes, operations usually being carried out at from 40 to 90° C., preferably from 50 to 85° C., and in particular 55 to 80° C., and in the presence of a free-radical inhibitor.

Free-radical polymerization and also undesired crosslinking reactions of unsaturated functional groups are inhibited by the inhibitor and, if appropriate, by operating under an inert gas. Examples of these inhibitors are hydroquinone, the monomethyl ether of hydroquinone, phenothiazine, derivatives of phenol, e.g. 2-tert-butyl-4-methylphenol, 6-tert-butyl-2,4-dimethylphenol, or N-oxyl compounds, such as N-oxyl-4-hydroxy-2,2,6,6-tetramethylpiperidine (hydroxy-TEMPO), N-oxyl-4-oxo-2,2,6,6-tetramethylpiperidine (TEMPO), in amounts of from 50 to 2000 ppm by weight, based on the entirety of the monomers A₂ and B₃.

The inventive process may preferably be carried out batchwise, or else continuously, for example in stirred vessels, tubular reactors, tower reactors, or other conventional reactors, which may have static or dynamic mixers, and conventional apparatus for pressure control and temperature control, and also for operations under an inert gas.

In the case of operation without solvent, the final product is generally obtained directly and, if necessary, can be purified via conventional purification operations. If concomitant use has been made of a solvent, this may be removed in the usual way from the reaction mixture after the reaction, for example via vacuum distillation.

The polyamides obtainable by the inventive process are likewise provided by the invention, as is the use of the polyamides for the production of moldings, foils, fibers, or foams, and also the moldings, foils, fibers, and foams composed of the inventive polyamides.

The inventive process features great simplicity. It permits the preparation of hyperbranched polyamides in a simple one-pot reaction. There is no need for isolation or purification of precursors or protective groups for precursors. The process has economic advantages, because the monomers are commercially available and inexpensive.

The molecular architecture of the resultant polyamides may be adjusted via use of chain extenders C, and tailored chemical modification of the polymer can be achieved via introduction of comonomers D.

### EXAMPLES

All of the experiments were carried out in a temperature-controllable, evacuatable three-necked round-bottomed flask with internal thermometer, with stirring and under nitrogen. The viscosity of the reaction mixture was checked visually or via sampling and measurement. The water produced during the reaction was removed by applying a vacuum and collected in a distillation apparatus. DETA means diethylenetriamine.

The following properties were determined on the resultant polymer or prepolymer and are stated in the table:

Viscosity to ISO 2884, using a REL-ICI cone-and-plate viscometer from Research Equipment London, at the temperature stated in the table.

Acid number to DIN 53402-2 in milligrams of potassium hydroxide per gram of polymer.

Molecular weight: number-average Mn and weight-average Mw via gel permeation chromatography/size exclusion chromatography (GPC/SEC) at 40° C., using a 0.05% strength by weight solution of potassium trifluoroacetate in hexafluoroisopropanol (HFIP) as eluent and HFIP gel columns (polystyrene/divinylbenzene, from Polymer Laboratories).

### Comparative Examples

### Dicarboxylic Acid A₂ and Triamine A3, Molar Ratio A₂:B₃ Being <1:1

### Comparative Example I

80 g (0.547 mol) of adipic acid were used as initial charge and were melted at 150° C. 84.7 g (0.821 mol) of DETA were added dropwise at 120° C. within a period of 1 hour to the melt, and the water was removed in vacuo (30 mbar). During the dropwise addition process, the viscosity of the reaction mixture rose slowly and uniformly. After the dropwise addition process, the mixture was allowed to continue reaction at 120° C. until the viscosity ceased to rise further, after a continued reaction time of 1.5 hours. The reaction was terminated by allowing the mixture to cool to 20° C. The resultant polyamide was slightly yellowish and relatively viscous.

### Inventive Examples

### Dicarboxylic Acid A₂ and Triamine A3, Molar Ratio A₂:B₃ Being from 1.1:1 to 20:1

### Inventive Example 1

Single-Stage Reaction

92 g (0.63 mol) of adipic acid were used as initial charge and were melted at 150° C. 54 g (0.525 mol) of DETA were added dropwise at 150° C. within a period of 1 hour to the melt, and the water was removed in vacuo (50 mbar). During the dropwise addition process, the viscosity of the reaction mixture rose slowly and uniformly. After the dropwise addition process, the mixture was allowed to continue reaction at 130° C. As soon as the viscosity rose sharply (i.e. prior to reaching the gel point), the reaction was terminated by allowing the mixture to cool to 20° C. The resultant polyamide was slightly yellow and viscous.

### Inventive Example 2

Single-Stage Reaction

300 g (2.053 mol) of adipic acid were used as initial charge and were melted at 150° C. 84.7 g (0.821 mol) of DETA were added dropwise at 150° C. within a period of 1 hour to the melt, and the water was removed in vacuo (200 mbar). During the dropwise addition process, the viscosity of the reaction mixture rose slowly and uniformly. After the dropwise addition process, the mixture was allowed to continue reaction at 120° C. As soon as the viscosity rose sharply (i.e. prior to reaching the gel point), the reaction was terminated by allowing the mixture to cool to 20° C. The resultant polyamide was slightly yellow and viscous.

### Inventive Example 3

Two-Stage Reaction

a) 120 g (0.821 mol) of adipic acid were used as initial charge and melted at 150° C. 26 g (0.257 mol) of DETA were added dropwise at 150° C. within a period of 1 hour to the melt, and the water was removed in vacuo (200 mbar). During the dropwise addition process, the viscosity of the reaction mixture rose slowly and uniformly. After the dropwise addition process, the mixture was allowed to continue reaction at 110° C. As soon as the viscosity rise ceased (indicating the end of the reaction), the viscosity, the acid number and the molecular weights were determined on a specimen of the resultant prepolymer.

b) Taking the acid number of the prepolymer as a basis, the resultant reaction mixture was treated via dropwise addition at 110° C. of 1 molar equivalent of DETA (i.e. 1 mol of DETA per mole of carboxy end groups, the number of carboxy end groups being determined from the acid number), and the mixture was allowed to continue reaction at that temperature. Specimens taken during the polymerization initially showed a marked rise in molecular weight and viscosity, and then showed a falling acid number. After 6 hours of continued reaction time, the reaction was terminated by allowing the mixture to cool to 20° C. The resultant polyamide was slightly yellowish and viscous.

### Inventive Example 4

Two-Stage Reaction

a) 149.5 g (1.023 mol) of adipic acid were used as initial charge and were melted at 150° C. 33 g (0.320 mol) of DETA were added dropwise at 150° C. within a period of 1 hour to the melt, and the water was removed in vacuo (200 mbar). During the dropwise addition process, the viscosity of the reaction mixture rose slowly and uniformly. After the dropwise addition process, the mixture was allowed to continue reaction at 110° C. As soon as the viscosity rose sharply (i.e. prior to reaching the gel point), the reaction was terminated by allowing the mixture to cool to 20° C., a specimen of the resultant prepolymer was taken, and its acid number was determined.

b) Taking the acid number of the prepolymer as a basis, the resultant reaction mixture was treated via dropwise addition at 110° C. of 1 molar equivalent of DETA, and the mixture was allowed to continue reaction at that temperature. Specimens taken during the course of the polymerization initially showed a marked increase in molecular weight and viscosity, and then showed a falling acid number. After 4 hours of continued reaction time, the reaction was terminated by allowing the mixture to cool to 20° C. The resultant polyamide was slightly yellowish and highly viscous.

### Inventive Example 5

Two-Stage Reaction

a) 100 g (0.684 mol) of adipic acid were used as initial charge and were melted at 150° C. 14 g (0.137 mol) of DETA were added dropwise at 150° C. within a period of 1 hour to the melt, and the water was removed in vacuo (200 mbar). During the dropwise addition process, the viscosity of the reaction mixture rose slowly and uniformly. After the dropwise addition process, the mixture was allowed to continue reaction at 110° C. As soon as the viscosity rose sharply (i.e. prior to reaching the gel point), the reaction was terminated by allowing the mixture to cool to 20° C., a specimen of the resultant prepolymer was taken, and its acid number was determined.

b) Taking the acid number of the prepolymer as a basis, the resultant reaction mixture was treated via dropwise addition at 110° C. of 1 molar equivalent of DETA, and the mixture was allowed to continue reaction at that temperature. Specimens taken during the course of the polymerization initially showed a marked increase in molecular weight and viscosity, and then showed a falling acid number. After 8 hours of continued reaction time, the reaction was terminated by allowing the mixture to cool to 20° C. The resultant polyamide was slightly yellowish and viscous.

### Inventive Example 6

Two-Stage Reaction in Solution

a) 65 ml of a mixture composed of 70% by volume of 1,4-dioxane and 30% by volume of water were used as initial charge, and 50 g (0.342 mol) of adipic acid and 10 g (0.068 mol) of tris(2-aminoethyl)amine were dissolved therein. The reaction was initiated via heating of the mixture to 100° C. After a reaction time of 9.5 hours at that temperature, a specimen of the reaction mixture was taken and freed from solvent mixture, and its acid number was determined.

b) Taking the acid number of the prepolymer as a basis, the resultant reaction mixture was treated via dropwise addition of 1 molar equivalent of tris(2-aminoethyl)amine at 100° C., and the mixture was allowed to continue reaction at that temperature for 13 hours. The mixture was then allowed to cool and the solvent mixture was removed in vacuo. The resultant polyamide was slightly yellowish and viscous.

### Inventive Example 7

Single-Stage Reaction with Stearic Acid Comonomer

92 g (0.63 mol) of adipic acid and 1.5 g (0.005 mol) of stearic acid were used as initial charge and were melted at 150° C. 54 g (0.525 mol) of DETA were added dropwise at 150° C. within a period of 1 hour to the melt, and the water was removed in vacuo (400 mbar). During the dropwise addition process, the viscosity of the reaction mixture rose slowly and uniformly. After the dropwise addition process, the mixture was allowed to continue reaction at 110° C. As soon as the viscosity rose sharply (i.e. prior to reaching the gel point), the reaction was terminated by allowing the mixture to cool to 20° C. The resultant polyamide was slightly yellow and viscous.

### Inventive Example 8

Single-Stage Reaction with Benzoic Acid Comonomer

200 g (1.369 mol) of adipic acid and 2.6 g (0.011 mol) of benzoic acid were used as initial charge and were melted at 150° C. 117.7 g (1.14 mol) of DETA were added dropwise at 150° C. within a period of 1 hour to the melt, and the water was removed in vacuo (140 mbar). During the dropwise addition process, the viscosity of the reaction mixture rose slowly and uniformly. After the dropwise addition process, the mixture was allowed to continue reaction at 110° C. As soon as the viscosity rose sharply (i.e. prior to reaching the gel point), the reaction was terminated by allowing the mixture to cool to 20° C. The resultant polyamide was slightly yellow and viscous.

### Inventive Example 9

Single-Stage Reaction Using Isophoronediamine Chain Extender

92 g (0.63 mol) of adipic acid were used as initial charge and were melted at 150° C. 35.7 g (0.346 mol) of DETA and 29.5 g (0.173 mol) of isophoronediamine were added dropwise at 150° C. within a period of 1 hour to the melt, and the water was removed in vacuo (200 mbar). During the dropwise addition process, the viscosity of the reaction mixture rose slowly and uniformly. After the dropwise addition process, the mixture was allowed to continue reaction at 110° C. As soon as the viscosity rose sharply (i.e. prior to reaching the gel point), the reaction was terminated by allowing the mixture to cool to 20° C. The resultant polyamide was a colorless solid.

The table gives the results.

TABLE
Test results (— means not determined)

| | Viscosity ¹⁾ | Acid number | Mol. weight | Mol. weight |
|---|---|---|---|---|
| Example | [mPa · s] | [mg KOH/g] | Mn [g/mol] | Mw [g/mol] |
| I | 1800 (100° C.) | 0 | 3500 | 5700 |
| 1 | 4800 (150° C.) | 137 | 7400 | 13100 |
| 2 | 1700 (150° C.) | 417 | — | — |
| 3a | 4200 (100° C.) | 498 | 3400 | 4450 |
| 3b | 1200 (150° C.) | 73 | 5800 | 11800 |
| 4a | 4800 (100° C.) | 468 | 3700 | 4890 |
| 4b | 3600 (150° C.) | 194 | 8800 | 16200 |
| 5a | 200 (125° C.) | 521 | 3600 | 4420 |
| 5b | 800 (125° C.) | 47 | 4000 | 6400 |
| 6a | — | 737 | 1770 | 2150 |
| 6b | — | 143 | 1620 | 2180 |
| 7 | 2200 (125° C.) | 144 | 4100 | 6200 |
| 8 | 6200 (125° C.) | 221 | 5700 | 8800 |
| 9 | 3200 (125° C.) | 172 | 3200 | 4460 |

¹⁾ Test temperature in brackets

1. A process for preparation of highly branched or hyperbranched polyamides, which comprises reacting a first monomer A₂ having at least two functional groups A with a second monomer B₃ having at least three functional groups B, where
1) the functional groups A and B react with one another, and
2) one of the monomers A and B is an amine and the other of the monomers A and B is a carboxylic acid, and
3) the molar ratio of A₂:B₃ is from 1.1:1 to 20:1.

2. The process according to claim 1, wherein
2a) either the monomer A₂ is a carboxylic acid having at least two carboxyl groups and the monomer B₃ is an amine having at least three amino groups,
2b) or the monomer A₂ is an amine having at least two amino groups, and the monomer B₃ is a carboxylic acid having at least three carboxy groups.

3. The process according to claim 1, wherein the reactivities of the two amino groups of the monomer A₂ or of the three amino groups of the monomer B₃ are identical or different.

4. The process according to claim 1, wherein the amino groups are identical and the molar ratio of A₂:B₃ is from 1.2:1 to 3:1.

5. The process according to claim 1, wherein the amino groups are different and the monomers A₂ and B₃ are reacted with one another in a molar ratio of A₂:B₃ of from 2.5:1 to 20:1, giving a prepolymer having the functional groups A as end groups, and then this prepolymer is reacted with further monomer B₃ or with a monomer B₂ having 2 functional groups B.

6. The process according to claim 1, wherein the monomer A₂ comprises a dicarboxylic acid and the monomer B₃ comprises a triamine.

7. The process according to claim 1, wherein the monomer A₂ comprises adipic acid and the monomer B₃ comprises diethylenetriamine or tris(2-aminoethyl)amine.

8. The process according to claim 1, which, during or after the reaction of the monomers A₂ and B₃, makes concomitant use of a monomer C acting as chain extender.

9. The process according to claim 1, which, prior to, during or after the reaction of the monomers A₂ and B₃, makes concomitant use of a comonomer D having a functional group, giving a modified polyamide.

10. A polyamide, obtainable by the process according to claim 1.

11. A method for producing moldings, foils, fibers, or foams comprising adding the highly branched or hyperbranch polyamide produced by the process of claim 1 to a molding, foil, fiber or foam formulation.

12. A molding, a foil, a fiber or a foam comprising the polyamide according to claim 10.

13. The process according to claim 2, wherein the reactivities of the two amino groups of the monomer A₂ or of the three amino groups of the monomer B₃ are identical or different.

14. The process according to claim 2, wherein the amino groups are identical and the molar ratio of A₂:B₃ is from 1.2:1 to 3:1.

15. The process according to claim 3, wherein the amino groups are identical and the molar ratio of A₂:B₃ is from 1.2:1 to 3:1.

16. The process according to claim 2, wherein the amino groups are different and the monomers A₂ and B₃ are reacted with one another in a molar ratio of A₂:B₃ of from 2.5:1 to 20:1, giving a prepolymer having the functional groups A as end groups, and then this prepolymer is reacted with further monomer B₃ or with a monomer B₂ having 2 functional groups B.

17. The process according to claim 3, wherein the amino groups are different and the monomers A₂ and B₃ are reacted with one another in a molar ratio of A₂:B₃ of from 2.5:1 to 20:1, giving a prepolymer having the functional groups A as end groups, and then this prepolymer is reacted with further monomer B₃ or with a monomer B₂ having 2 functional groups B.

18. The process according to claim 4, wherein the amino groups are different and the monomers A₂ and B₃ are reacted with one another in a molar ratio of A₂:B₃ of from 2.5:1 to 20:1, giving a prepolymer having the functional groups A as end groups, and then this prepolymer is reacted with further monomer B₃ or with a monomer B₂ having 2 functional groups B.

19. The process according to claim 2, wherein the monomer A₂ comprises a dicarboxylic acid and the monomer B₃ comprises a triamine.

20. The process according to claim 3, wherein the monomer A₂ comprises a dicarboxylic acid and the monomer B₃ comprises a triamine.
